(19) United States
(12) Patent Application Publication
(10) Pub. No.: US 2005/0002380 A1
(43) Pub. Date: Jan. 6, 2005

(54) Automated IT asset location system

(76) Inventors: Robert S. Miller, Endwell, NY (US); Daniel J. Driscoll, Ithaca, NY (US); Lyle Haff JR., Owego, NY (US); Raymond S. Rush, Endwell, NY (US); Jaime L. Wightman, Endicott, NY (US); John R. Yaichuk, Binghamton, NY (US)

Correspondence Address: WALL MARJAMA & BILINSKI, 101 SOUTH SALINA STREET, SUITE 400, SYRACUSE, NY, 13202, US

(21) Appl. No.: 10/835,857

(22) Filed: Apr. 30, 2004

Related U.S. Application Data
(60) Provisional application No. 60/468,974, filed on May 9, 2003.

(51) Int. Cl. H04L 12/66

(52) U.S. Cl. 370/352

(57) ABSTRACT

The present invention is directed to a computerized method for locating and tracking devices in a network. The method including the step of querying the network to obtain network device connectivity data for each device coupled to the network. Device relational data is retrieved from at least one database. The network device connectivity data is correlated with the device relational data to obtain an asset tracking record for each device. The asset tracking record includes device location data, device identification data, and device responsibility data.

### CROSS-REFERENCE TO RELATED APPLICATIONS

This application claims priority under 35 U.S.C. §119(e) based on U.S. Provisional Patent Application Ser. No. 60/468,974, filed May 6, 2003, the contents of which are relied upon and incorporated herein by reference in their entirety.

### BACKGROUND OF THE INVENTION

1. Field of the Invention

The present invention relates generally to tracking IT assets, and particularly to tracking IT assets in a networked environment.

2. Technical Background

Organizations often require a modern and efficient Information Technology (IT) infrastructure in order to effectively perform their assigned tasks. For example, businesses cannot compete in the market place without some sort of IT infrastructure. Depending on the organization, an IT infrastructure may include hundreds, or even thousands, of networked IT assets. A local area network (LAN) is usually configured to operate within a limited geographic area, such as an office, a building, or a small cluster of buildings. A typical LAN may interconnect IT assets such as servers, switches, routers, workstations, personal computers, printers, display devices, and internet protocol (IP) telephones to enhance the organization's communication abilities, share computing resources, and lower communications/travel costs. A LAN allows users to share resources such as files, application programs, printers, and/or other software/hardware resources. Accordingly, an organization may buy fewer devices and purchase only one software license for shared applications. There are other benefits as well, a LAN increases worker efficiency and productivity because of the ready access to shared information. Larger organizations may include entities situated at various geographical locations. In this instance, the organization may support a wide area network (WAN). A WAN may be configured as a system of interconnected LANs. As such, the organization's IT assets will be disposed in one or more networks that may span metropolitan, regional, national, continental, or international geographical areas. While LANs and WANs offer many benefits, the burden of managing these networks may be significant. In particular, the task of locating and tracking an organization's IT assets may be problematic.

One way of identifying an IT asset would be to employ inherent network addressing. Consider that most LANs provide their users with access to external networks. The access is usually provided by a router that is configured to couple the LAN to an external network. Within the LAN, the router may be connected to several LAN switch devices. These network switch devices are often used to define a LAN segment. Each LAN segment may include a network switch that is equipped with a multiplicity of network switch ports. Each switch port accommodates a network device (i.e., personal computers, servers, printers, hubs, and etc.). Accordingly, each router, network switch, and device may be uniquely identified by an internet protocol (IP) address. As such, these devices may be accessed via the external network using the IP address. Further, the network switch identifies each attached network device by a unique Media Access Control (MAC) address. Thus, it is conceivable that in a static network environment, the MAC node address alone may be used to uniquely identify a network asset.

However, many network environments are not static in nature. IT managers must respond to rapidly changing conditions that may cause LAN interconnections to change. Employees are often transferred to other departments within an organization. Employees may change employers. New workers may join the organization. The business itself may be restructured or moved to a new location. The interrelationship between the workers, the workers' department(s), the workers' physical locations, the physical location of a network device, and the MAC address may change on a regular basis. Thus, the MAC address alone will not solve the problem of efficiently locating and tracking IT assets.

To further exacerbate the problem, network devices may be grouped logically to form a virtual LAN (VLAN). The logical grouping is implemented in software that resides in the network switch. In a VLAN, logically related network devices perform as if they were connected to the same LAN segment, despite the fact that they may not be physically connected to the segment. A VLAN is not limited by the existing physical network design and/or cabling infrastructure. A VLAN can be re-segmented to respond to changing conditions and/or throughput bottlenecks with software modifications. Essentially, a VLAN allows IT managers to reconfigure the LAN in software. However, because the physical location of network devices does not conform to the logical grouping of those devices within the VLAN, confusion may arise.

Current IT management systems do not provide an effective means for locating, tracking, and/or managing network devices as they migrate to different locations in response to the changing environment. Because organizations often invest substantial resources in information technology, an effective and efficient way to track, locate, and manage IT resources is urgently needed. The method should be automated to avoid using costly manpower to perform this necessary task.

### SUMMARY OF THE INVENTION

The present invention addresses the issues raised in the Background of the Invention. The present invention provides a means for tracking and locating network devices in a LAN environment. The present invention automates this task. Thus, the present invention is efficient and cost effective.

One aspect of the present invention is a computerized method for locating and tracking devices in a network. The method including the step of querying the network to obtain network device connectivity data for each device coupled to the network. Device relational data is retrieved from at least one database. The network device connectivity data is correlated with the device relational data to obtain an asset tracking record for each device. The asset tracking record includes device location data, device identification data, and device responsibility data.

In another aspect, the present invention is directed to a computerized method for locating and tracking devices in a network. The network includes at least one network switch. The at least one network switch includes a plurality of switch ports. The method includes the step of querying the at least one network switch to obtain a switch port list. The switch port list associates a device network address with each of the plurality of switch ports having a network device coupled thereto. Network data is retrieved for the at least one network switch. The network data associates physical location data to each device network address. The network data and the switch port list are correlated to obtain an address/location list. The address/location list includes device location data and a device network address for each network device. Asset tracking data is retrieved for each network device. The asset tracking data associates device identification data with the corresponding device network address. The asset tracking data and the address/location list are correlated to obtain a device location list. The device location list includes the physical location data and the device identification data for each network device. Asset ownership data is retrieved for each network device. The asset ownership data associating the device identification data with responsible entity identification data. The asset ownership data and the device location list are correlated to obtain a asset tracking record for each device, the asset tracking record including the device location data, the device identification data, and the responsible entity identification data.

In another aspect, the present invention is directed to a system for locating and tracking devices in a network. The network includes at least one network switch. The at least one network switch includes at least one switch port. The system including at least one database configured to store relational data for at least one device. A processor coupled to the at least one database. The processor is configured to query the at least one network switch to obtain network device connectivity data for the at least one switch port, retrieve device relational data from the at least one database, and correlate the network device connectivity data with the device relational data to obtain an asset tracking record for the at least one device, the asset tracking record including device location data, device identification data, and device responsibility data.

In another aspect, the present invention is directed to a computer system that includes a graphical user interface having at least one data input device and at least one data output device coupled to the computer system. The graphical user interface is employed to perform a method for locating and tracking devices in a network. The network includes at least one network switch. The at least one network switch includes at least one switch port. The method includes the step of entering at least one device responsibility identifier with the at least one data input device. The network is queried to obtain network device connectivity data. Device relational data is retrieved for each device related to the at least one device responsibility identifier. The network device connectivity data is correlated with the device relational data to obtain an asset tracking record for each device. The asset tracking record includes device location data, device identification data, and a device responsibility identifier. An asset tracking report is provided to the at least one output device, the asset tracking report including the asset tracking records corresponding to the at least one device responsibility identifier.

In another aspect, the present invention is directed to a computer readable medium having stored thereon a data structure. The data structure represents an asset tracking report. The asset tracking report provides data for at least one network device. The data structure includes a device responsibility field including data corresponding to a party responsible for the at least one network device. The data structure also includes at least one asset tracking record including data corresponding to the at least one network device, the asset tracking record including device location data, device identification data, and a date the at least one asset tracking record was generated.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description are merely exemplary of the invention, and are intended to provide an overview or framework for understanding the nature and character of the invention as it is claimed. The accompanying drawings are included to provide a further understanding of the invention, and are incorporated in and constitute a part of this specification. The drawings illustrate various embodiments of the invention, and together with the description serve to explain the principles and operation of the invention.

### BRIEF DESCRIPTION OF THE DRAWINGS

FIG. 1 is a block diagram of an embodiment of the automated IT Asset location system in accordance with the present invention;

FIG. 2 is a detailed diagrammatic depiction of a virtual LAN in accordance with another embodiment of the present invention;

FIG. 3 is a flow chart showing a method for locating IT assets in accordance with the present invention;

FIG. 4 is a graphical user interface in accordance with the present invention; and

FIG. 5 is another graphical user interface in accordance with the present invention.

### DETAILED DESCRIPTION

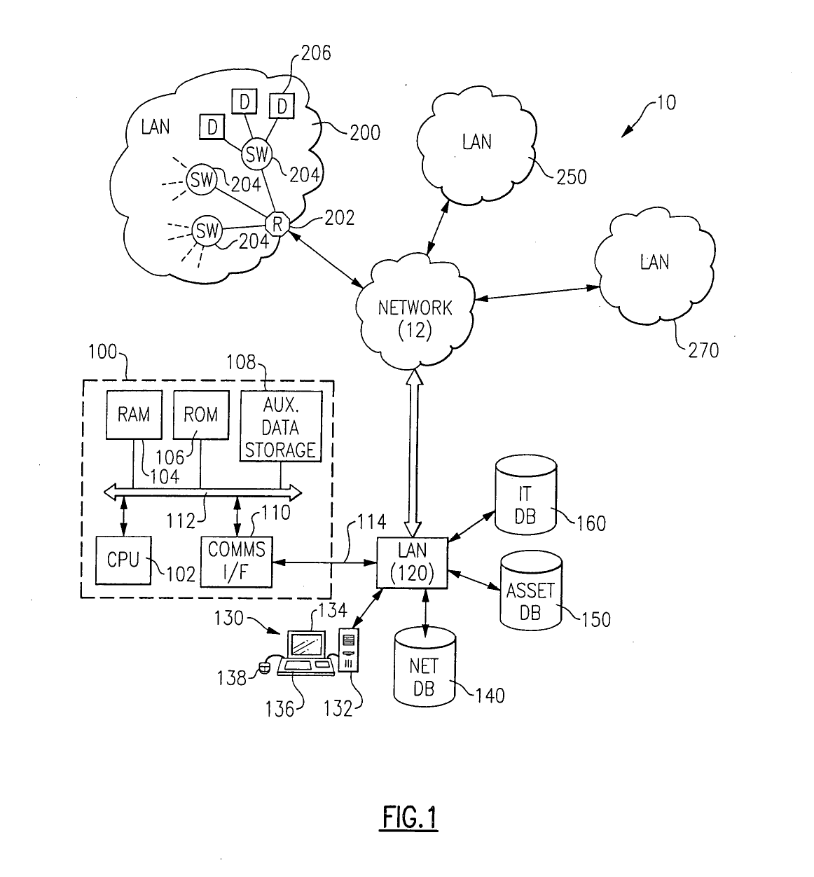

Reference will now be made in detail to the present exemplary embodiments of the invention, examples of which are illustrated in the accompanying drawings. Wherever possible, the same reference numbers will be used throughout the drawings to refer to the same or like parts. An exemplary embodiment of the Automated Information Technology (IT) Asset Location System of the present invention is shown in FIG. 1, and is designated generally throughout by reference numeral 10.

In accordance with the invention, the present invention is directed to a computerized method for locating and tracking devices in a network. The method including the step of querying the network to obtain network device connectivity data for each device coupled to the network. Device relational data is retrieved from at least one database. The network device connectivity data is correlated with the device relational data to obtain an asset tracking record for each device. The asset tracking record includes device location data, device identification data, and device responsibility data.

As embodied herein, and depicted in FIG. 1, a block diagram of an embodiment of the Automated IT Asset Location System 10 is disclosed. System 10 includes server computer 100 coupled to personal computers 130, network database 140, asset tracking database 150, and IT identifier database 160, by way of LAN 120. In another embodiment, computer 100 may be directly coupled to computers (or workstations) 130, and database 140, database 150, and database 160. LAN 102 is connected to external network 12. In another embodiment, computer 100 may be directly coupled to external network 12. External network 12 provides system 10 with access to LAN 200, LAN 250, and LAN 270. Those of ordinary skill in the art will recognize that the present invention may service any number of LANs coupled to external network 12. Furthermore, those of ordinary skill in the art will also recognize that the present invention is configured to locate and track IT assets in a WAN that may be comprised of LAN 200, LAN 250, LAN 270, or other such networks.

In the example shown in FIG. 1, LAN 200 interfaces with network 12 by way of router 202. Router 202 is coupled to network switches 204. Switches 204 may support a multiplicity of network devices 206. In one embodiment, system 10 is configured to query switches 204 by using the IP addresses of the switches. Each switch 204 is queried to obtain its switch port list residing in memory. The switch port list includes a port-device pair for each switch port in switch 204. Each port-device pair includes the network switch port and the data link layer address, or layer-2 address, of the network device associated with the network switch port. It will be apparent to those of ordinary skill in the pertinent art that modifications and variations can be made to the software utility used to query network switches 204 depending on whether the utility employs off-the-shelf software or customized software. However, in one embodiment of the present invention the utility commonly known as “snmpwalk” is used to query switches 204. As those of ordinary skill in the art will recognize that the snmpwalk utility is an SNMP application that uses SNMP GETNEXT requests to query a network entity for a tree of information. Of course, the Simple Network Management Protocol (SNMP) is an application layer protocol that facilitates the exchange of management information between network devices. SNMP is part of the Transmission Control Protocol/Internet Protocol (TCP/IP) protocol suite. SNMP enables network administrators to manage network performance, find and solve network problems, and plan for network growth.

As noted previously, when the LAN or WAN conforms to IEEE 802, the data link layer of the OSI reference model includes two sub-layers; the logical link control sub-layer and the media access control (MAC) layer. The MAC address is a hardware address that uniquely identifies each node, or device, that is coupled to the network, in this case LAN 200. For example, a personal computer typically includes a PC network interface card (NIC) that has a unique MAC hardware address. Every networked device, including servers, printers, routers, cable modems, or network hubs, to name a few, has a MAC address.

Referring to FIG. 1, server computer 100 is configured to locate and track IT assets in the various networks mentioned above. Server 100 includes bus 112 which is used to interconnect processor 102, RAM 104, ROM 106, other auxiliary storage device 108, and communications interface 110. Random access memory (RAM) 104 is used to store the data and instructions that are to be executed by processor 102. RAM 104 may also be used for storing temporary variables or other intermediate information during execution of instructions by the processor 102. Read only memory (ROM) 106, or some other static storage device, is configured to store the program code, e.g., the computer-executable instructions, used by processor 102. ROM 106 is also used to store static data. Server computer 100 also includes communication interface 110. Interface 110 is coupled to bus 112, and provides a two-way data communication coupling to a network link 114. As shown in the example of FIG. 1, network link 114 may provide a connection to LAN 120.

During operation, when a portion of the code is to be executed, it is retrieved from ROM 106 and written into an appropriate register in RAM 104. Auxiliary data storage device 108 may be of any suitable type of media and is used for long-term storage of data, instructions, and/or applications. Storage device 108 may include memory ICs, a hard disk or other magnetic media, or a CD/ROM device or other optically read media.

Thus, server computer 100 includes at least one computer readable medium or memory for holding instructions programmed according to the teachings of the invention and for containing data structures, tables, records, or other data described herein. Common forms of computer-readable media include RAM, ROM, PROM, EPROM, FLASH-EPROM, E²PROM, and/or any other memory chip or cartridge. Computer-readable media may also include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia. Computer readable medium also may include any medium from which a computer can read.

In one embodiment of the invention, the method for locating and tracking IT assets is performed by server computer 100 when processor 102 executes an arrangement of instructions contained in RAM 104. These instructions are typically read into RAM 104 from ROM 106, but can be read from another computer-readable medium, such as auxiliary storage device 108. Execution of the arrangement of instructions contained in RAM 104 causes processor 102 to perform the process steps described herein. It will be apparent to those of ordinary skill in the pertinent art that modifications and variations can be made to processor 1100 of the present invention depending on cost, speed and timing, and other design considerations. For example, processor 102 may be implemented using a suitable processor of the type manufactured by Intel, AMD, Motorola, or by other manufacturer's of comparable devices. Processor 102 may also be customized to include a reduced instruction set (RISC) processor or a application specific integrated circuit (ASIC). In alternative embodiments, hard-wired circuitry may be used in place of or in combination with software instructions to implement the embodiment of the present invention. Thus, the implementation of the present invention is not limited to any specific combination of hardware circuitry and software.

Communication interface 110 may be of any suitable type depending on the nature of link 114. For example, interface 110 may include a local area network (LAN) card (e.g. for Ethernet™ or an Asynchronous Transfer Model (ATM) network) to provide a compatible data communication connection to LAN 120. However, those of ordinary skill in the art will recognize that interface 110 is not limited to the embodiment shown in FIG. 1. Communication interface 110 may also include a digital subscriber line (DSL) card or modem, an integrated services digital network (ISDN) card, a cable modem, a telephone modem, or any other communication interface to provide a data communication connection to a corresponding type of communication line. Wireless links can also be implemented. In any such implementation, communication interface 110 sends and receives electrical, electromagnetic, or optical signals that carry digital data representing various types of information. Further, the communication interface 110 may include peripheral interface devices, such as a Universal Serial Bus (USB) interface, a PCMCIA (Personal Computer Memory Card International Association) interface, and etc. Although a single communication interface 110 is depicted in FIG. 1, interface 110 may include multiple communication interfaces.

As noted above, the network link 114 provides data communication between interface 110 and LAN 120, or to other networks and data devices, depending on the implementation. As shown, network link 114 connects computer 100 to personal computer 130, database 140, database 150, database 150, and network 12 by way of LAN 120. In another embodiment, network link 114 may directly access external network 12.

It will be apparent to those of ordinary skill in the pertinent art that network 12 may be of any suitable type, including but not limited to, a wide area network (WAN), the public switched telephone network (PSTN), a packet switched network such as an Internet Protocol (IP) network, the global packet data communication network now commonly referred to as the “Internet,” any wireless network, or to data equipment operated by a service provider. LAN 120 and network 12 both use electrical, electromagnetic, or optical signals to carry data and instructions. The signals propagating through communication interface 110, link 114, and the various networks, are exemplary forms of carrier waves bearing the information and/or instructions.

Transmission media may include coaxial cables, copper wires, fiber optics, printed circuit board traces and drivers, such as those used to implement the computer system bus. Transmission media can also take the form of acoustic, optical, or electromagnetic waves, such as those generated during radio frequency (RF) and infrared (IR) data communications.

Personal Computer/work station (PC) 130 may be of any suitable type depending on cost and other functionality issues. PC 130 typically includes RAM, ROM, a processor and a communications interface coupled by way of a bus system. These components are typically disposed in housing 132. PC 130 also includes display 134, input device 136, and cursor control device 138. It will be apparent to those of ordinary skill in the pertinent art that modifications and variations can be made to display 134 of the present invention depending on cost or other design considerations. For example, display 134 may include a cathode ray tube (CRT), a liquid crystal display, an active matrix display, or a plasma display. Those of ordinary skill in the art will recognize that input device 136 may be of any suitable type, such as a keyboard that includes alphanumeric and other keys. Input device 136 is employed by a user to communicate information and command selections to the processor. Cursor control mechanism 138 may be a mouse, a trackball, or cursor direction keys. Mechanism 138 is used to communicate directional information and command selections to the processor, and is also used to control cursor movement on display 134.

Databases 140, 150, and 160 may be of any suitable type. In one embodiment, the databases are of the type provided by Oracle Corporation. In another embodiment, databases 140, 150, and 160 may reside on a single database server. In fact, these databases may reside in server computer 100. Databases 140, 150, and 160 are shown separately in FIG. 1 for clarity of illustration.

Network database 140 includes location data. This database relates each network switch port to a device wall port, which may be used to define the physical location of the device connected to the wall port. Asset tracking database 150 relates the MAC address of a particular device to a device serial number. The device serial number corresponds to a device type (e.g., a PC, printer, etc.), a device model, and other identifying information. Thus, this information in database 150 links the network interface card (NIC) in the device to a particular device. IT Asset database 160 relates the serial number of each network device to an organizational identifier. For example, the organizational identifier may correspond to a particular department within a corporation, in which case, the data pair relates the serial number to the department that owns, or is responsible for, the network device.

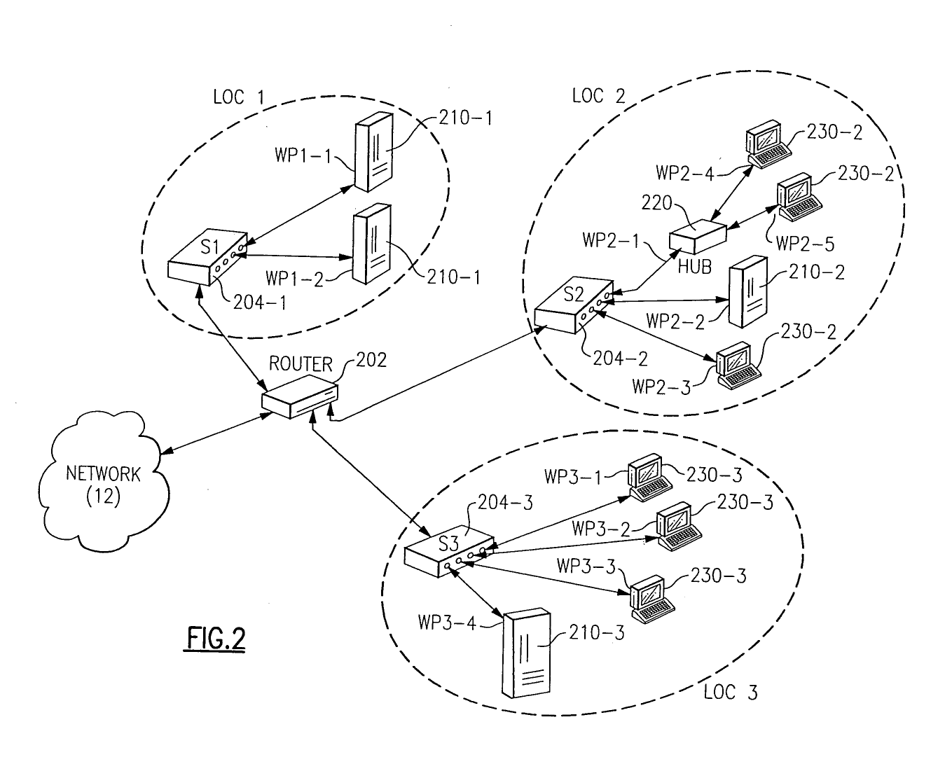

Referring to FIG. 2, a detailed diagrammatic depiction of LAN 200 depicted FIG. 1 is shown. As noted above, LANs 200, 250, and/or 270 may be implemented using VLAN technology. FIG. 2 provides one illustration of the problem solved by the present invention. The IT assets disposed in LAN 200 may be disposed in numerous locations. In the Example provided, network 12 is coupled to router 202. Router 202 is connected to switch 204-1 in location 1, to switch 204-2 in location 2, and to switch 204-3 in location 3. Location 1, 2, and 3 may represent various floors in a single building, multiple buildings, or a combination thereof. As shown, switch 204-1 includes a first switch port coupled to server 210-1 and a second switch port coupled to another server 210-1. LAN segment 2 includes switch 204-2 coupled to hub 220-2, Server 210-2, and PC 230-2. Hub 220-2 is coupled to PCs 230-2. LAN segment 3 includes switch 204-3 coupled to router 202. Switch 204-3 includes switch ports that are coupled to server 210-3 and PCs 230-3.

The interconnection between switches 204 and the network devices (IT assets) typically includes several segments of transmission media. Each switch port is connected to a wall port by a transmission cable. The wall port is connected to transmission media disposed in the building. The transmission media is connected to a wall port in the vicinity of the network device. In one embodiment, the device wall port number determines the physical location of the device. Those of ordinary skill in the art will recognize that other location identifiers may be employed as well.

The switches employed in the present invention may be of any suitable type depending on cost and performance issues. For example, switches 204 may be of a type manufactured by Cisco Networks. In one embodiment, each switch 204 includes a content addressable memory (CAM). A CAM is much faster than other memory devices because addressing each memory location does not require use of an address bus. A CAM compares the requested information with the entire list of pre-stored data simultaneously. In this case, the pre-stored data relates to the MAC address associated with each network switch port in the switch. The CAM retrieves each MAC address corresponding to a defined network switch port.

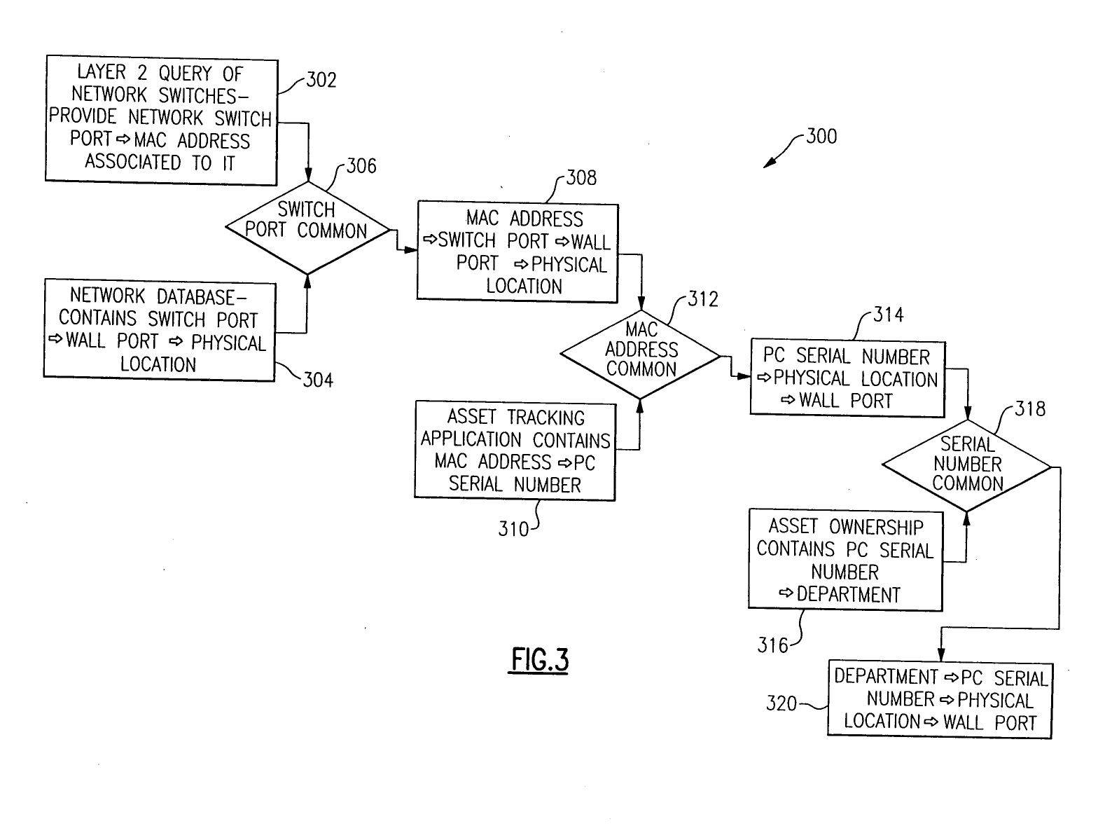

As embodied herein, and depicted in FIG. 3, a flow chart showing a method for locating IT assets is disclosed. As noted above, the method for locating and tracking IT assets is typically performed by server computer 100 when processor 102 executes an arrangement of instructions contained in RAM 104. In step 302, processor 102 queries the CAM in selected network switches in a selected LAN or WAN. Processor 102 obtains the MAC address associated with each switch port of the selected network switches. Processor 102 accesses database 140 to obtain the location data associated with the switch port. The location data relates a wall port number with each switch port. The location data may also relate each wall port with a physical location corresponding to the wall port. In step 306, processor 102 correlates the data obtained from the network switches with the data obtained from network database 140 to obtain the list 308. The list 308 associates each MAC address with a switch port, a wall port and a physical location. In step 310, processor 102 queries database 150 to obtain asset tracking data. As noted above, the asset tracking data relates each MAC address to a network device serial number. In step 312, processor 102 correlates the MAC addresses in the asset tracking data with the MAC addresses in list 308 to obtain list 314. List 314 maps each network device serial number with the wall port and physical location. After processor 102 retrieves IT asset identification data from database 160, the serial number information in the identification data and list 314 is correlated to produce device list 320. List 320 includes the responsible organization, the wall port, and physical location associated with each network device serial number.

Those of ordinary skill in the art will recognize that the method depicted in FIG. 3 can be periodically executed by server computer 100 to obtain a current view of an organization's IT assets. Further, derivative reports may be generated by users via personal computers 130 to manage the IT assets. For example, each department may readily determine where its IT assets are located and make management decisions accordingly. Further, IT management personnel may use the data generated by the present invention to respond to a changing business environment. As noted above, switch loading may be impacted by new employees, or other worker dislocations that may alter the interrelationship between the worker, the worker's department, the worker's physical location, and the physical location of a network device. Those of ordinary skill in the art will also understand that the databases employed by the present invention may be easily maintained in software using the same information used to implement the software changes required during VLAN alterations.

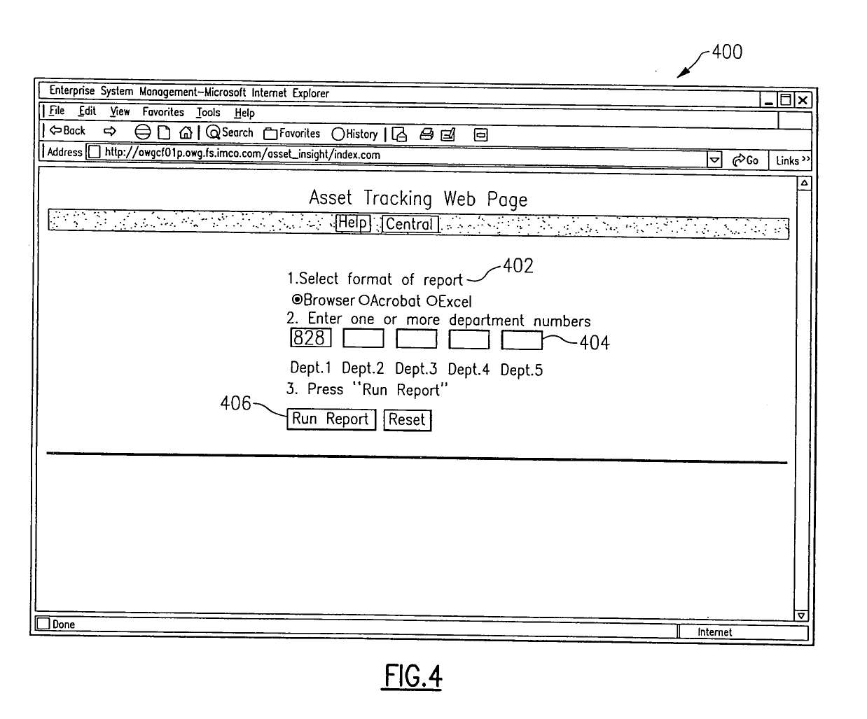

Referring to FIG. 4, a graphical user interface (GUI) in accordance with the present invention is disclosed. GUI 400 provides a asset tracking web page that may be accessed by way of a web browser. Those of ordinary skill in the art will understand that the web browser may reside on computer 100 or another server computer. In this page, the present invention allows a user to retrieve IT assets by department. In menu item 402 the user selects the format of the report. The format selections include a browser format, an Acrobat PDF format, or an excel spreadsheet format. In this case, the user selects the browser format. Thus, the user may obtain the information from display 134 or from a hard copy. Menu selector 404 allows user to enter several depart numbers. After the department number is entered, the user clicks on button 406 to run the report. At this point, PC 130 retrieves list 320 from computer 100 and formats the data in accordance with the selected format.

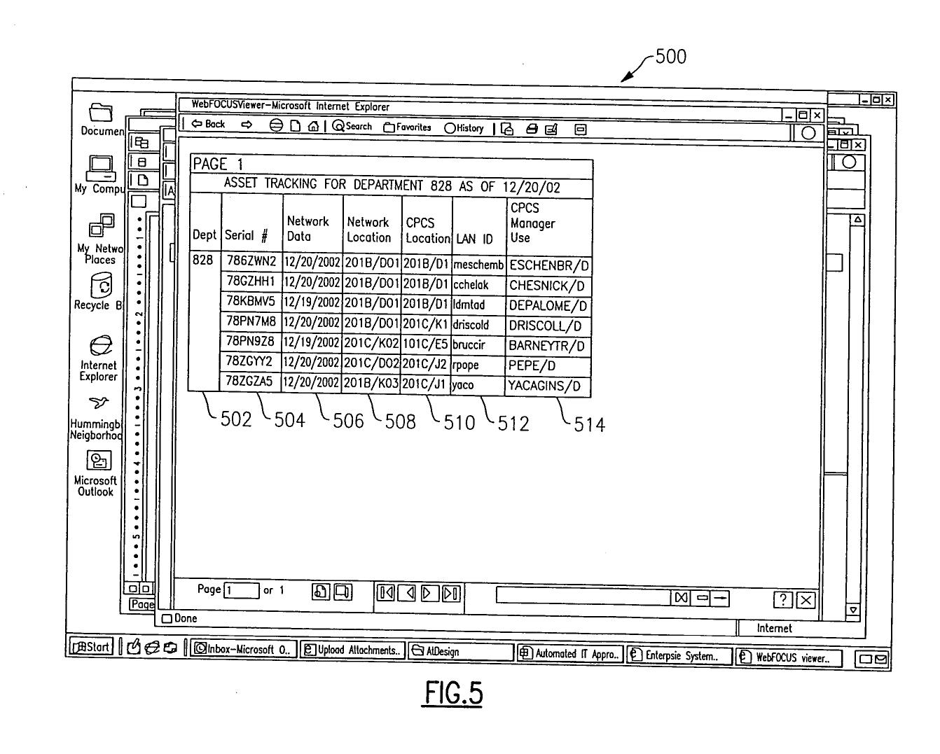

Referring to FIG. 5, another graphical user interface in accordance with the present invention is shown. After the user clicks the run button 406, the data is provided in a browser format page 500. Page 500 includes department identifier field 502, a serial number field 504, a network date field 506, a network segment location field 508, a network device location field 510, a LAN or VLAN identifier field 512, and the manager responsible for the network device. Network date field 506 includes the date when the device information was obtained. Referring to FIG. 2, network location field 508 provides the physical location of the LAN segment. The network device location field 510 provides the wall port number of the associated device.

Those of ordinary skill in the art will understand that the report examples shown in FIG. 4 and FIG. 5 are merely examples of the report types that may be generated using the data obtained by the present invention. The present invention should not be construed as being limited to these examples.

It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents.

1. A computerized method for locating and tracking devices in a network, the method comprising:
querying the network to obtain network device connectivity data for each device coupled to the network;
retrieving device relational data from at least one database; and
correlating the network device connectivity data with the device relational data to obtain an asset tracking record for each device, the asset tracking record including device location data, device identification data, and device responsibility data.

2. The method of claim 1, wherein the step of querying includes querying each network switch in the network to obtain the network device connectivity data.

3. The method of claim 2, wherein the network device connectivity data includes a device network address for each switch port in the network switch.

4. The method of claim 3, wherein the network address is a MAC address.

5. The method of claim 3, wherein the network address is a data link layer address.

6. The method of claim 1, wherein the at least one database includes the asset tracking record for each device, the asset tracking record including the device relational data for the device, the device relational data associating at least a portion of the device connectivity data with the device location data, the device identification data, and the device responsibility data

7. The method of claim 6, wherein the portion of the device connectivity data includes a MAC address.

8. The method of claim 6, wherein the portion of the device connectivity data includes a data link layer address.

9. The method of claim 1, further comprising the step of displaying an asset tracking report, the report including the at least asset tracking record.

10. The method of claim 9, wherein the step of displaying includes displaying all asset tracking records having identical ownership data.

11. The method of claim 9, wherein the step of displaying includes printing the report.

12. The method of claim 9, wherein the report includes a time the report was generated.

13. A computerized method for locating and tracking devices in a network, the network including at least one network switch, the at least one network switch including at least one switch port, the method comprising:
querying the at least one network switch to obtain a switch port list, the switch port list associating a device network address with the at least one switch port;
retrieving network data for the at least one network switch, the network data associating physical location data to each device network address;
correlating the network data and the switch port list to obtain an address/location list, the address/location list including device location data and a device network address for each network device;
retrieving asset tracking data for each network device, the asset tracking data associating device identification data with the corresponding device network address;
correlating the asset tracking data with the address/location list to obtain a device location list, the device location list including the physical location data and the device identification data for each network device;
retrieving asset ownership data for each network device, the asset ownership data associating the device identification data with responsible entity identification data; and
correlating the asset ownership data with the device location list to obtain a asset tracking record for each device, the asset tracking record including the device location data, the device identification data, and the responsible entity identification data.

14. A system for locating and tracking devices in a network, the network including at least one network switch, the at least one network switch including at least one switch port, the system comprising:
at least one database configured to store relational data for at least one device; and
a processor coupled to the at least one database, the processor being configured to,
query the at least one network switch to obtain network device connectivity data for the at least one switch port,
retrieve device relational data from the at least one database, and
correlate the network device connectivity data with the device relational data to obtain an asset tracking record for the at least one device, the asset tracking record including device location data, device identification data, and device responsibility data.

15. The system of claim 14, wherein the network device connectivity data includes a switch port list, the switch port list associating a device network address to the at least one switch port.

16. The system of claim 15, wherein the at least one database stores network data for the at least one network switch, the network data associating the device location data to each device network address.

17. The system of claim 16, wherein the processor is further configured to:
correlate the network data and the switch port list to obtain an address/location list, the address/location list including the device location data and a device network address for each network device;
retrieve asset tracking data for each network device, the asset tracking data associates the device identification data with the corresponding device network address;
correlate the asset tracking data with the address/location list to obtain a device location list, the device location list including the device location data and the device identification data for each network device;
retrieve asset ownership data for each network device, the asset ownership data associates the device identification data with the corresponding device responsibility data; and
correlate the asset ownership data with the device location list to obtain the asset tracking record.

18. The system of claim 14, wherein the processor and the at least one database are included in a server computer system.

19. The system of claim 14, wherein the processor and the at least one database are coupled by a local area network (LAN).

20. The system of claim 20, wherein the processor queries the at least one network switch by way of the LAN.

21. The system of claim 14, further comprising a communications interface coupled to the processor, the communications interface being configured to provide bi-directional communications between the processor and the at least one network switch.

22. The system of claim 14, wherein the network includes a plurality of network switches, each network switch including at least one switch port, the processor being configured to query each of the plurality of network switches.

23. The system of claim 15, further comprising at least one user accessible device, the user accessible device including at least one input device configured to provide input data and/or instructions to the system, and at least one output device configured to receive output data.

24. The system of claim 23, wherein the output data includes an asset tracking report, the asset tracking report including the at least asset tracking record.

25. The system of claim 24, wherein the at least one output device includes a display device configured to display the asset tracking report.

26. The system of claim 24, wherein the asset tracking report displays all asset tracking records having the corresponding device responsibility data.

27. The system of claim 24, wherein the at least one output device includes a printer.

28. The system of claim 23, wherein the report includes a time the report was generated.

29. In a computer system including a graphical user interface having at least one data input device and at least one data output device coupled to the computer system, a method for locating and tracking devices in a network, the network including at least one network switch, the at least one network switch including at least one switch port, the method comprising:
entering at least one device responsibility identifier with the at least one data input device;
querying the network to obtain network device connectivity data;
retrieving device relational data for each device related to the at least one device responsibility identifier;
correlating the network device connectivity data with the device relational data to obtain an asset tracking record for each device, the asset tracking record including device location data, device identification data, and a device responsibility identifier; and
providing an asset tracking report to the at least one output device, the asset tracking report including the asset tracking records corresponding to the at least one device responsibility identifier.

30. The method of claim 29, wherein the at least one output device includes a display device.

31. The method of claim 29, wherein the at least one output device includes a printer device.

32. The method of claim 29, wherein the network device connectivity data includes a switch port list, the switch port list associating a device network address to each switch port.

33. The method of claim 32, wherein the relational data includes network address data, asset tracking data, and a device responsibility identifier.

34. The method of claim 33, wherein the steps of retrieving and correlating further comprise:
correlating the network address data and the switch port list to obtain an address/location list, the address/location list including the device location data and the device network address for each device;
retrieving the asset tracking data for each device, the asset tracking data associating the device identification data with the corresponding device network address;
correlating the asset tracking data with the address/location list to obtain a device location list, the device location list including the device location data and the device identification data for each device;
retrieving the device responsibility identifier for each network device, the device responsibility identifier associating the device identification data with the device responsibility identifier; and
correlating the device responsibility identifier with the device location list to obtain the asset tracking record.

35. A computer readable medium having stored thereon a data structure, the data structure representing an asset tracking report, the asset tracking report providing data for at least one network device, the data structure comprising:
a device responsibility field including data corresponding to a party responsible for the at least one network device; and
at least one asset tracking record including data corresponding to the at least one network device, the asset tracking record including device location data, device identification data, and a date the at least one asset tracking record was generated.

36. The data structure of claim 35, wherein the at least one asset tracking record includes network identification data.

37. The data structure of claim 35, wherein the at least one asset tracking record includes management personnel data.
